(19) United States
(12) Patent Application Publication
(10) Pub. No.: US 2026/0179322 A1
(43) Pub. Date: Jun. 25, 2026

(54) AI-ASSISTED MARKUPS METHODS AND SYSTEMS

(71) Applicant: Zazzle Inc., Menlo Park, CA (US)

(72) Inventors: Matthew DIFONZO, Belmont, CA (US); Leslie Young HARVILL, Menlo Park, CA (US)

(21) Appl. No.: 18/990,266

(22) Filed: Dec. 20, 2024

(51) Int. Cl. G06T 17/20; G06F 3/14; G06T 3/40; G06T 3/60; G06T 7/13

(52) U.S. Cl. CPC G06T 17/20; G06F 3/14; G06T 3/40; G06T 3/60; G06T 7/13

(57) ABSTRACT

A computer-implemented method and apparatus for generating a quadrilateral grid from an image with an alpha channel. The method includes receiving an image with an alpha channel depicting a shape mapped onto a 3D surface, vectorizing the shape to create a vector path, determining corners by calculating a centroid and identifying the points, correcting a winding order to ensure a clockwise orientation, constructing a quadrilateral grid by setting sub-paths based on detected corners, resampling the sub-paths to match specified rows and columns, performing weighted interpolation across the grid using inverse square distance weighting, and outputting the generated quadrilateral grid for display on a computer device. The apparatus comprises a processor configured to execute these steps, including vectorizing the shape, determining corners, correcting the winding order, constructing and resampling the grid, performing weighted interpolation, and subdividing the 3D mesh for flexible manipulation and extrapolation.

### TECHNICAL FILED

One technical field of the present disclosure is digital image processing. Another technical field is a computer-implemented technique for defining, capturing, and using markups on customizable items. Another technical field is a computer-implemented technique for applying markups to assemble and display customized content accurately and effectively.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

With the growth of digital computation capabilities and enhancements in manufacturing processes, goods manufacturing is transforming into producing goods according to individual customization requests received from customer computers. For instance, manufacturers usually fulfill online orders from customers who use their computer systems to customize depictions of generic goods and place online orders for individually customized goods.

Generally, synthetic views are digital depictions of customized objects on computer-based display devices. In the context of digital customization of products, rendering synthetic views of the products before the products are manufactured is quite beneficial. Rendering synthetic views allows a user to visually check the product features and decorations before actually ordering the product. Synthetic views are often a combination of imagery from digital photography. They may include, for example, digital markups and synthetic renderings derived from, for example, 2D, 2.5D, and 3D geometry of the objects.

A markup image is an image that can be annotated with various tools to add notes, shapes, or other markings. In the context of this disclosure, a markup allows marking up a custom product, such as a mug, photograph, t-shirt, and the like, and applying another image to the marked-up custom product.

Some systems on the market offer users the opportunity to order products with customized attributes. For example, in the case of custom-manufactured framed products such as photos, digital images, artwork, and other frameable products, the systems may offer the users the opportunity to order frames with customized sizes and colors. Such systems often provide functionalities for displaying depictions, i.e., synthetic views, of the customized products to help the users visualize their customized products before ordering them. However, customizing the products with many parameters may be quite challenging. In fact, in some situations, the selection of customization values may negatively affect the appearance and rendering of the final custom products.

Therefore, there is a need to develop systems and methods that allow customizing products with many attributes and characteristics that overcome the shortcomings described above.

### SUMMARY

The included claims provide a summary of the presented approach.

### BRIEF DESCRIPTION OF THE DRAWINGS

The patent or application file contains at least one drawing executed in color. The Patent Office will provide copies of this patent or patent application publication with color drawings upon request and payment of the necessary fee.

The manner in which the above-recited features of the present disclosure can be understood in detail, a more particular description of the disclosure, briefly summarized above, may be had by reference to aspects, some of which are illustrated in the appended drawings. It is to be noted, however, that the appended drawings illustrate only typical aspects of this present disclosure and are therefore not to be considered limiting of its scope, for the present disclosure may admit to other equally practical aspects.

FIG. 1A is a block diagram showing an example environment for the AI-based markup generation.

FIG. 1B depicts examples of markups applied to example custom products.

FIG. 1C depicts an example of conforming a markup area to a layout specification.

FIG. 1D depicts an example of finding a markup.

FIG. 1E depicts a segmentation example.

FIG. 1F depicts a markup removal example.

FIG. 1G depicts an example of generating a rectangular grid.

FIG. 1H depicts an example of depth estimation.

FIG. 1I depicts an isolation example.

FIG. 1J depicts a process of generating a dynamic composite image.

FIG. 2A is an example of utilizing an AI-based image generation approach.

FIG. 2B is an example of an AI-based image generator.

FIG. 3 is a block diagram showing an example environment for designing and manufacturing products.

FIG. 4A is a flow chart depicting an example process for generating and refining synthetic images of customizable products.

FIG. 4B is a flow chart depicting an example process for generating and validating digital markups on customizable products.

FIG. 4C is a flow chart depicting an example process for generating a quadrilateral grid from an image with an alpha channel.

FIG. 5 is a block diagram that illustrates a computer system with which the techniques herein may be implemented.

All the drawings, descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

### DESCRIPTION OF EXAMPLE EMBODIMENTS

The following description outlines numerous specific details to understand the present approach thoroughly. It will be apparent, however, that the present approach may be practiced without these specific details. In other instances, well-known structures and devices are shown in block diagram form to avoid unnecessarily obscuring the present approach.

Embodiments are described herein according to the following outline:
1.0. GENERAL OVERVIEW
   1.1. TECHNICAL PROBLEM-TECHNICAL SOLUTION
   1.2. TECHNICAL EFFECTS
   1.3. APPROACH SUMMARY
2.0. NOVELTY ASPECTS
   2.1. EXAMPLES OF NOVEL ASPECTS
   2.2. MARKUPS NOVEL ASPECTS
   2.3. QUADRILATERAL NOVEL ASPECTS
3.0. EXAMPLE EMBODIMENTS
   3.1. EXAMPLE EMBODIMENTS OF THE PRESENT PROCESS
   3.2. EXAMPLE EMBODIMENTS OF THE PRESENT APPARATUS
4.0. COMPUTATION ENVIRONMENT
5.0. GENERATING PRODUCTS WITH MARKUPS
6.0. CONFORMING MARKUP AREAS TO LAYOUT SPECIFICATIONS
7.0. FINDING A MARKUP
8.0. BACKGROUND SEGMENTATION EXAMPLE
9.0. REMOVING MARKUPS
10.0. GENERATING A GRID
11.0. DEPTH ESTIMATION
12.0. ISOLATING LUMINANCE AND SPECULAR LIGHT
13.0. GENERATING DYNAMIC COMPOSITE IMAGES
14.0. EXAMPLE SYSTEM SPECIFICATION
15.0. GENERATING SYNTHETIC IMAGES USING AI
   15.1. REQUESTS
   15.2. AI-BASED IMAGE GENERATOR
   15.3. SYNTHETIC IMAGES
16.0. QUADRITERAL INTERPOLATION APPROACH
17.0. EXAMPLE COMPUTER ENVIRONMENTS
18.0. GENERATING AND REFINING SYNTHETIC IMAGES OF CUSTOMIZABLE PRODUCTS
   18.1. OVERVIEW
   18.2. EXAMPLE FLOW CHART FOR GENERATING AND REFINING SYNTHETIC IMAGES OF CUSTOMIZABLE PRODUCTS
19.0. GENERATING AND VALIDATING DIGITAL MARKUPS ON CUSTOMIZABLE PRODUCTS
   19.1. OVERVIEW
   19.2. EXAMPLE FLOW CHART FOR GENERATING AND VALIDATING DIGITAL MARKUPS ON CUSTOMIZABLE PRODUCTS
20.0. GENERATING A QUADRILATERAL GRID FROM AN IMAGE ALPHA CHANNEL
   20.1. OVERVIEW
   20.2. EXAMPLE FLOW CHART FOR GENERATING A QUADRILATERAL GRID FROM AN IMAGE ALPHA CHANNEL
21.0. EXAMPLE BENEFITS OF THE PRESENT APPROACH
22.0. IMPLEMENTATIONS MECHANISMS

In some implementations, the approaches for generating and modifying product markups and markup recognition on products using generative are presented. The approaches

### 1.0. General Overview

In some implementations, the approaches for the generating and modifying product markups and markup recognition on products using generative are presented. The approaches have been developed to overcome the shortcomings of traditional approaches for generating markups and overcome the issues caused by inconvenient and time-consuming printing markups.

### 1.1. Technical Problem—Technical Solution

In the realm of digital image processing, the customization of products has become increasingly prevalent. With the advent of advanced computational capabilities, manufacturers can now produce goods tailored to individual specifications provided by customers. This shift towards personalized manufacturing has necessitated the development of systems that can accurately and efficiently render digital depictions of customizable products. These digital depictions are often called synthetic views. They allow users to visualize their customized products before placing an order, ensuring that the final product meets their expectations.

Despite the advancements in digital image processing, current solutions for generating synthetic views of customizable products face several challenges. Many existing systems rely on traditional printing markups on products, which can be inconvenient and time-consuming. These methods often require physical prototypes and extensive photography sessions involving models and specific locations to capture the desired product images. This process not only incurs significant costs but also limits the flexibility and speed of customizations. Furthermore, the accuracy of these synthetic views is often compromised, as they may not fully conform to the physical specifications of the final product, leading to discrepancies between the digital depiction and the actual manufactured item.

The disclosed approach addresses these challenges by leveraging generative AI to create and refine synthetic images of customizable products. This method eliminates the need for physical prototypes and extensive photography, significantly reducing the time and cost associated with product customization. The system generates a synthetic image that accurately reflects the specified attributes using a text prompt to describe the product and desired markup. The synthetic image is then validated against physical product specifications to ensure conformity and advanced techniques such as quadrilateral grid interpolation and inpainting are employed to enhance the realism and detail of the image.

The final enhanced synthetic image is integrated into an interactive asset, allowing users to interact with and customize the product before manufacturing. This innovative approach streamlines the customization process and ensures that the digital depiction closely matches the final manufactured product.

### 1.2. Technical Effects

By receiving and processing a text prompt describing a product and a desired markup, the present methods allow for precise and user-specific customization of synthetic images, ensuring that the generated images meet the user's expectations and requirements.

Generating a synthetic image of the product with the markup using a generative AI system enables the creation of high-quality, realistic images without the need for physical prototypes, significantly reducing the time and cost associated with product visualization and customization.

Validating the synthetic image against physical product specifications ensures that the generated images conform to real-world manufacturing constraints, prevents discrepancies between the digital representation and the actual product, and enhances the customization process's reliability and accuracy.

Mapping the synthetic image onto a 3D surface using, for example, quadrilateral grid interpolation allows for accurate and realistic placement of the image on the product's surface, taking into account the product's geometry and contours, which improves the visual fidelity of the synthetic image.

Applying inpainting techniques to remove the markup while preserving underlying fabric details ensures that the final synthetic image maintains the texture and appearance of the original product, providing a more authentic and visually appealing result.

Incorporating lighting and specular effects to enhance the realism of the synthetic image adds depth and dimension to the image, making it more lifelike and visually engaging. That can improve user satisfaction and the decision-making process during product customization.

Integrating the enhanced synthetic image into an interactive asset for customizable product visualization allows users to interact with and modify the product design in real time, providing a dynamic and engaging user experience that can lead to higher customer satisfaction and better-informed purchasing decisions.

Providing the interactive asset for user interaction and customization before manufacturing enables users to make final adjustments. It also allows the user to approve the customization before manufacturing the product. That reduces the risk of errors in the final product design and increases the user's satisfaction.

The apparatus for generating and refining synthetic images of customizable products allows the integration of multiple specialized modules, each contributing to the overall functionality and efficiency of the system. The generative AI system is configured to create synthetic images with digital markups based on text and image input from a module that prepares the inputs based on key-values within the product description. The product description is based on how a product may be customized and manufactured. This reduces the time and cost associated with traditional product visualization methods.

The validation and correction module ensures that the synthetic images conform to physical product specifications, enhancing the accuracy and reliability of the generated images. This module uses machine learning algorithms to compare synthetic images against a database of physical product specifications, ensuring that the final product meets the required standards.

The 3D mapping and image synthesis module may employ quadrilateral grid interpolation to map user images onto 3D surfaces accurately. This technique allows for the realistic representation of the product's surface, taking into account, for example, the contours and folds of the fabric, which enhances the visual realism of the synthetic images.

The inpainting module is designed to remove digital markups from the synthetic images while preserving underlying fabric details. This ensures that the final image maintains the texture and appearance of the original fabric, providing a more authentic and visually appealing representation of the product.

The interactive asset creation system integrates synthetic images into interactive assets for customizable product visualization and manufacturing. This allows users to interact with and customize the product images in real-time, providing a more engaging and user-friendly experience.

The depth estimation and image mapping tools refine the placement and appearance of digital markups on 3D models, ensuring that the markups are accurately represented in the final image. This enhances the overall realism and accuracy of the synthetic images.

The lighting and specular effects module applies lighting and specular effects to the synthetic images, further enhancing their realism. By simulating various lighting scenarios, the module ensures that the synthetic images accurately reflect how the product would appear under different lighting conditions.

### 2.0. Novelty Aspects

### 2.1. Examples of Novel Aspects

In some implementations, the novelty of the present approaches lies in their comprehensive and technologically advanced approach to generating and refining synthetic images of customizable products using a combination of generative AI, validation techniques, and interactive visualization.

One of the novel aspects is using generative AI for synthetic image creation. The present method utilizes a generative AI system to create synthetic images of products based on text prompts describing the product and the desired markup. The approach allows for the rapid and flexible generation of product images without physical prototypes or photography.

Another aspect is validation against physical product specifications. The present method includes validating the synthetic images against physical product specifications to ensure conformity. This step ensures that the generated images accurately represent the physical products and meet manufacturing requirements.

Another novel aspect includes a 3D surface mapping using quadrilateral grid interpolation. The present method involves mapping the synthetic images onto 3D surfaces using quadrilateral grid interpolation. This technique ensures that the images conform to the contours and dimensions of the physical products, providing a realistic and accurate representation.

Other aspects include using inpainting techniques for markup removal. The present method applies inpainting techniques to remove digital markups from the synthetic images while preserving underlying fabric details. This step enhances the realism of the images by ensuring that the removal of markups does not affect the product's visual quality.

Additional aspects include the incorporation of lighting and specular effects. The method incorporates lighting and specular effects to enhance the realism of the synthetic images. This approach ensures the images accurately reflect the physical products' lighting conditions and material properties.

Other aspects include integration markups into interactive assets. The present method integrates the enhanced synthetic images into interactive assets for customizable product visualization. This allows users to interact with and customize the product images in real time, providing a highly engaging and user-friendly experience.

Other aspects include real-time customization and user interaction. The method provides interactive assets for user interaction and customization prior to manufacturing. This feature allows users to modify product features directly within the interactive asset, ensuring that the final product meets their preferences and requirements.

Additional aspects include the use of specific product attributes in text prompts. The method allows for including specific product attributes, such as color, size, or material, in the text prompts used to generate synthetic images. This ensures that the generated images accurately reflect the desired product characteristics.

Other novel aspects include using different AI models. The method utilizes different AI models to generate synthetic images, providing flexibility and adaptability in image generation.

Other aspects include the comparison with the Database of physical product specifications. The method includes comparing the synthetic images with a database of physical product specifications for validation, ensuring that the images conform to established standards and requirements.

Overall, the novelty of the present approach lies in its holistic and technologically advanced approach to generating, validating, and refining synthetic images of customizable products, incorporating generative AI, 3D surface mapping, inpainting techniques, lighting effects, and interactive visualization to provide a highly accurate and user-friendly solution for product customization and visualization.

### 2.2. Markups Novel Aspects

A markup is an image that can be annotated with various tools to add notes, shapes, or other markings, and that can be used to mark up a custom product. For example, a markup may be applied to custom products, such as mugs, photographs, t-shirts, and the like, to apply another image to the marked-up custom products.

Regarding markups, the novelty lies in its comprehensive approach to monitoring and managing communications within a role-based collaborative system using advanced technologies. Key novel aspects include machine learning and natural language processing. The collaboration server and monitoring system utilize machine learning algorithms and natural language processing (NLP) techniques to generate markups and improve the accuracy of generated markups.

### 2.3. Quadrilateral Novel Aspects

In terms of generating markups, the novelty of the present approach lies in its comprehensive and technologically advanced methods for generating a quadrilateral grid from an image with an alpha channel, specifically designed for digital image processing and customization. Key novel aspects include vectorizing shapes from the alpha channel. The present approach involves receiving an image with an alpha channel depicting a shape mapped onto a 3D surface and vectorizing the shape found in the alpha channel to create a vector path. This step ensures a precise and accurate shape representation for further processing.

Additional novel aspects include corner detection and centroid calculation. The present methods involve determining the corners of the vector path by calculating a centroid of the vector path and identifying the farthest points from the centroid to establish corner points. The approach ensures accurate identification of the shape's boundaries and corners.

Other novel aspects include winding order and orientation correction. The present method corrects the winding order and orientation of the vector path to ensure a clockwise order. The step is crucial for maintaining the correct orientation of the shape during grid construction.

Other novel aspects include constructing and resampling a quadrilateral grid: The method constructs a quadrilateral grid by setting sub-paths based on the detected corners and resampling the sub-paths to match a specified number of rows and columns. That ensures a uniform and consistent grid structure for further processing.

Additional aspects include weighted interpolation across the grid. The present method performs weighted interpolation across the grid by calculating interpolants for each grid element based on inverse square distance weighting and adjusting interpolated values by the distance from contributing edges. That approach provides a plausible physical representation of the shape on the 3D surface.

Other novel aspects include the output and display of the generated grid. The present method outputs the generated quadrilateral grid and causes the display of the generated output on a computer display device. That step ensures the final grid is accurately represented and visualized for further use.

Additional features and enhancements are recited in the dependent claims. The dependent claims introduce additional features such as normalizing the vector path to fit within a predefined coordinate system, smoothing the vector path using spline interpolation, verifying the clockwise order by calculating the surface normal, and using cubic weighting functions for enhanced accuracy. Those enhancements further improve the precision and reliability of the method.

Overall, the novelty lies in its detailed and systematic approach to generating a quadrilateral grid from an image with an alpha channel, incorporating advanced techniques for vectorization, corner detection, orientation correction, grid construction, and weighted interpolation, resulting in a highly accurate and reliable method for digital image processing and customization.

### 3.0. Example Embodiments

### 3.1. Example Embodiments of the Present Process

In some embodiments, the system for generating and refining synthetic images of customizable products utilizes a generative AI system that can accept text and image inputs to create highly detailed and accurate synthetic images. This system handles various product attributes, such as color, size, and material specified in the text prompt. The generative AI system can employ different AI models to generate synthetic images, ensuring versatility and adaptability in producing a wide range of product designs.

Once the synthetic image is generated, it undergoes a validation process where it is compared against a database of physical product specifications to ensure conformity. The validation step is important for maintaining the accuracy and reliability of the synthetic images. The system then maps the synthetic image onto a 3D surface using quadrilateral grid interpolation, which can be substituted with alternative interpolation methods like spline interpolation for different surface types. The mapping process ensures that the synthetic image conforms to the physical contours of the product, enhancing the realism of the synthetic image.

Inpainting techniques may be applied to remove any digital markups while preserving the underlying fabric details, using advanced texture synthesis algorithms to maintain the continuity of the fabric. The system also incorporates lighting and specular effects to enhance the realism of the synthetic image further, simulating various lighting scenarios such as natural or artificial light.

The enhanced synthetic image is then integrated into an interactive asset, allowing users to customize it in real-time. This interactive asset enables users to modify product features directly, providing a highly engaging and personalized experience. The final interactive asset is provided for user interaction and customization before manufacturing, ensuring that the end product meets the user's specifications and expectations. This embodiment demonstrates the system's adaptability and versatility in generating and refining synthetic images of customizable products, ensuring high accuracy and realism in the final output.

### 3.2. Example Embodiments of the Present Apparatus

In some embodiments, the generative AI system accepts text and image inputs for enhanced customization. It allows users to provide detailed descriptions and visual references to generate synthetic images that closely match their desired product specifications. This embodiment leverages advanced natural language processing and computer vision techniques to interpret and integrate the inputs, ensuring high accuracy and personalization in the generated images.

In some implementations, the generative AI system is designed to generate multiple design variations for user selection, offering a range of options that cater to different aesthetic preferences and functional requirements. The approach utilizes diverse AI models trained on various design styles and product categories, enabling the system to produce a wide array of synthetic images from which users can choose.

Additionally, the validation and correction module in one embodiment incorporates machine learning algorithms that continuously improve accuracy over time by learning from past corrections and user feedback. The adaptive learning capability ensures that the synthetic images remain consistent with physical product specifications, reducing the likelihood of discrepancies and enhancing the system's overall reliability.

In some embodiments, the 3D mapping and image synthesis module employs alternative interpolation methods, such as spline interpolation, to accommodate different surface types and achieve more precise and realistic mappings of synthetic images onto 3D models. This flexibility allows the system to handle a variety of product shapes and textures, ensuring that the synthetic images accurately reflect the physical characteristics of the products.

Furthermore, the inpainting module offers customizable inpainting parameters, enabling users to define the level of detail preservation according to their specific needs. This feature allows for greater control over the final appearance of the synthetic images, ensuring that important product details are maintained while unwanted elements are seamlessly removed.

In some implementations, the present processing techniques also include computational photography approaches and utilize various flow patterns and digital markup patents, field markup patents, and other types of processing.

### 4.0. Computation Environment

All the drawing figures herein and all of the descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

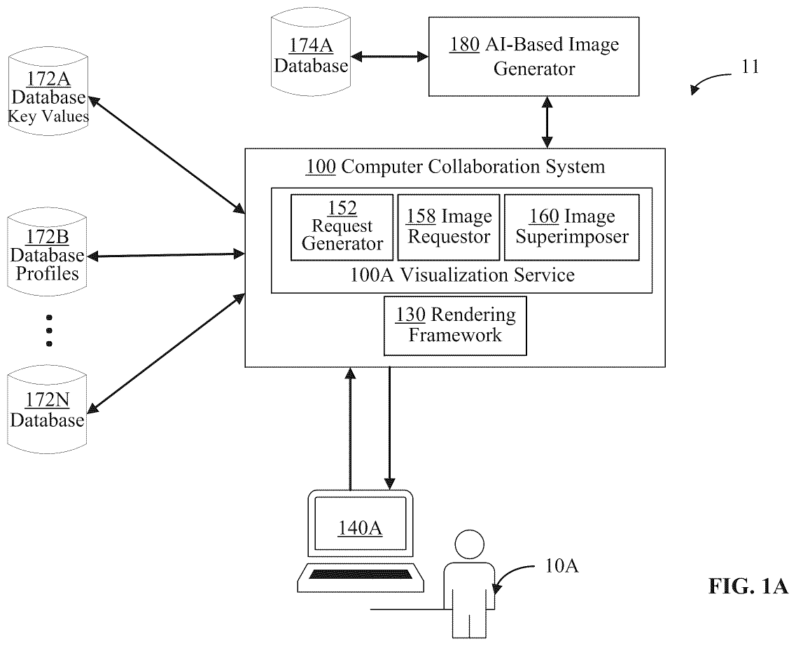

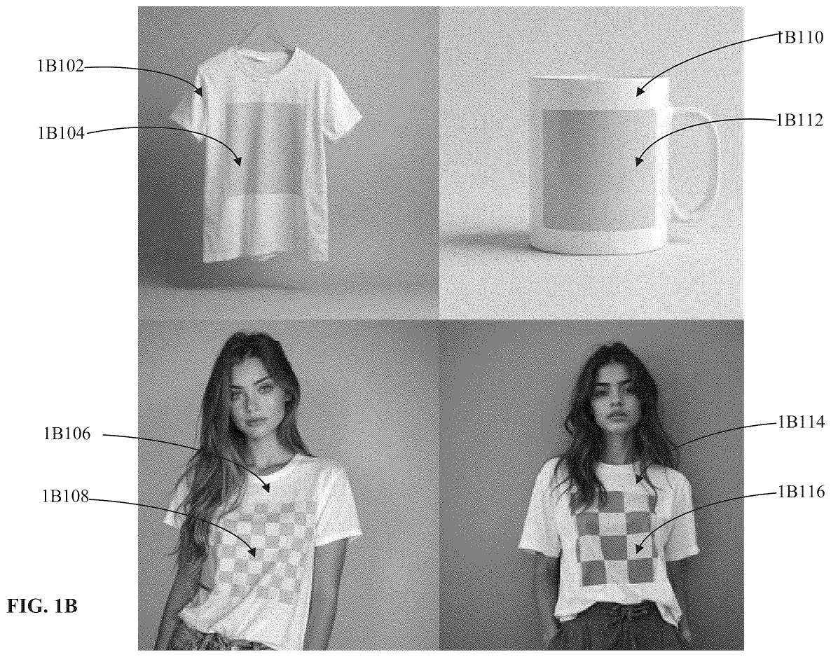

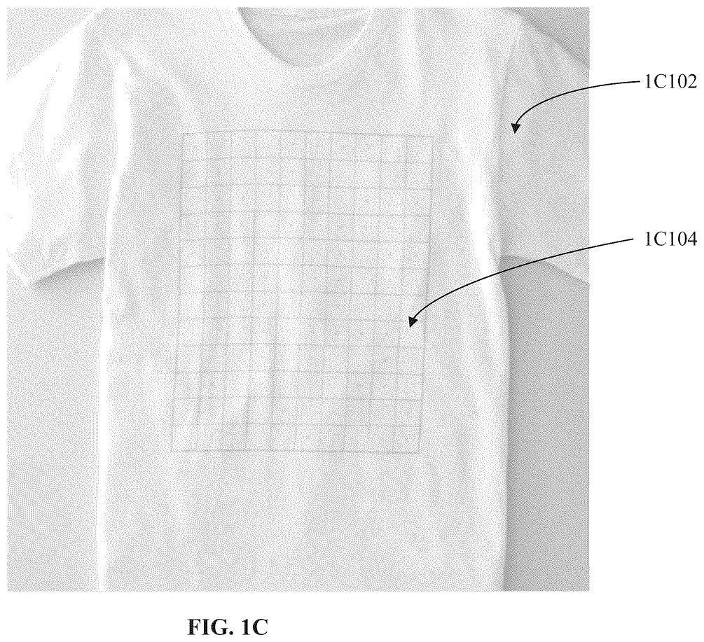

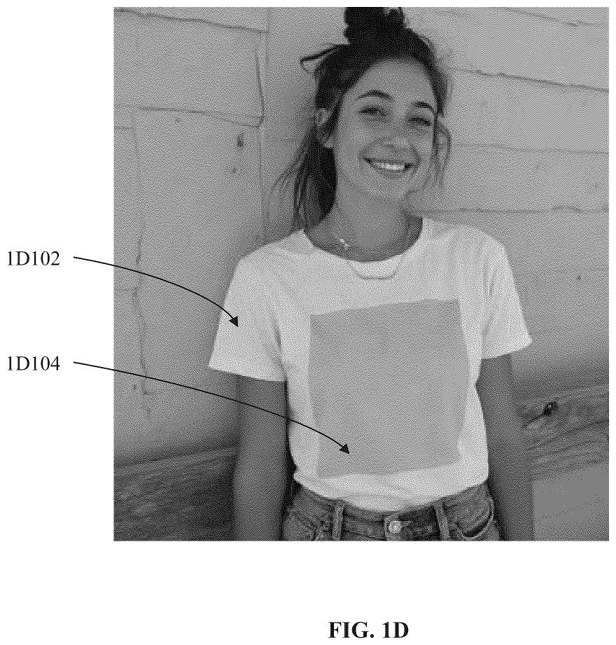

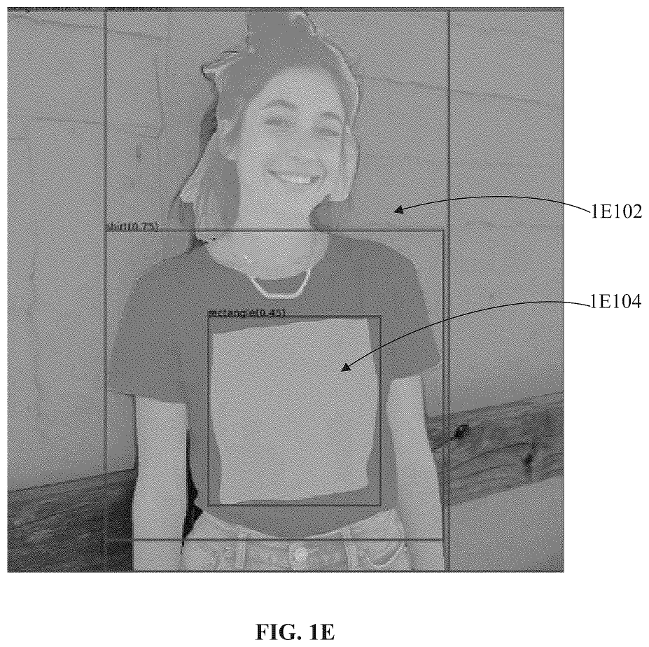

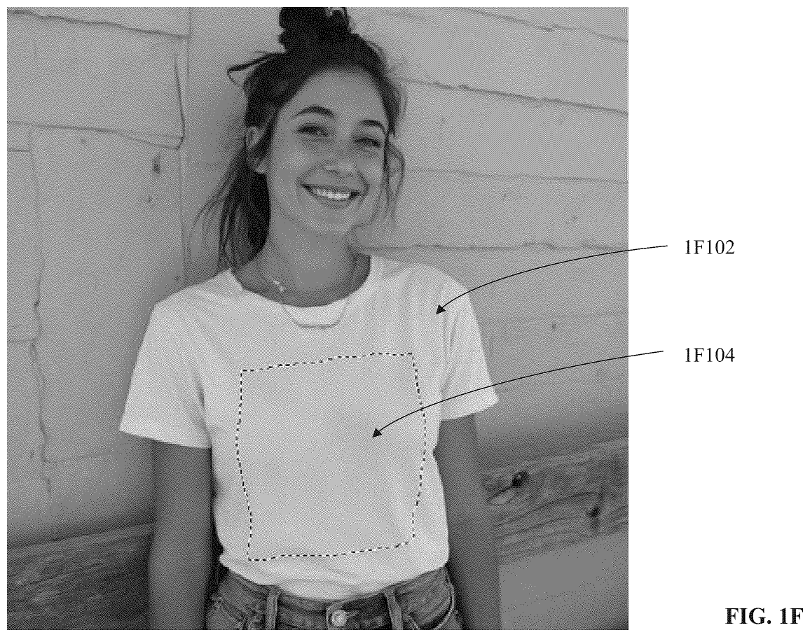

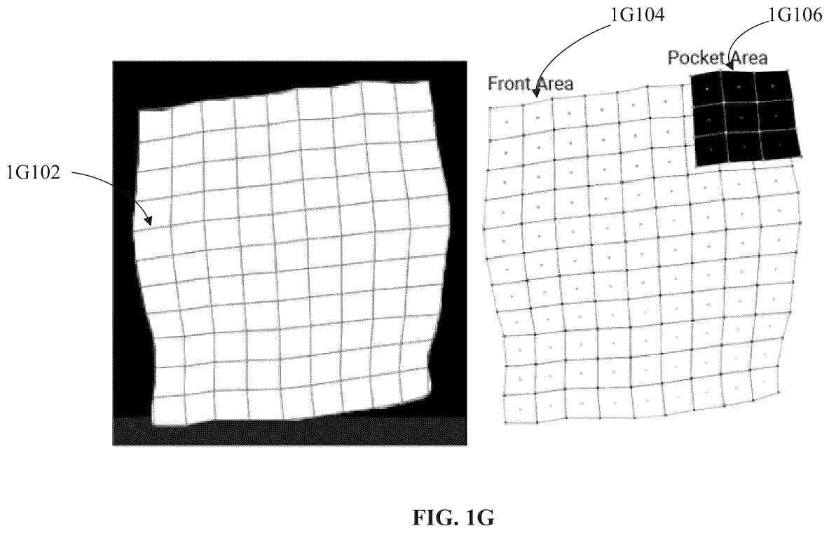

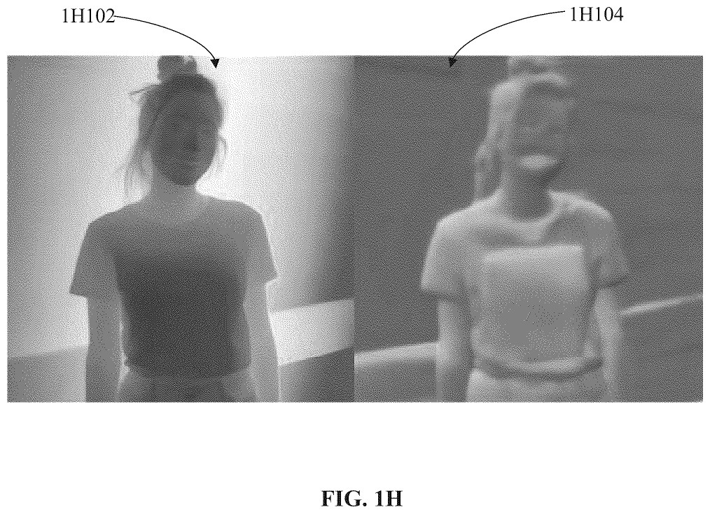

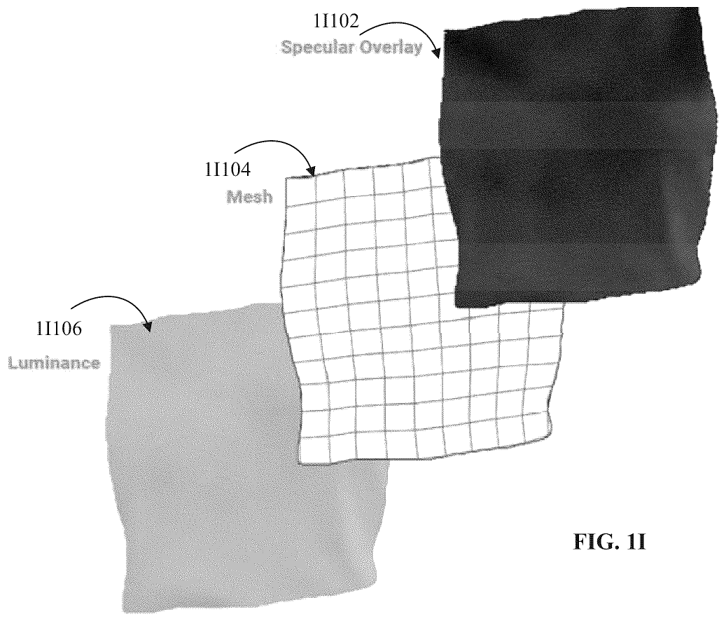

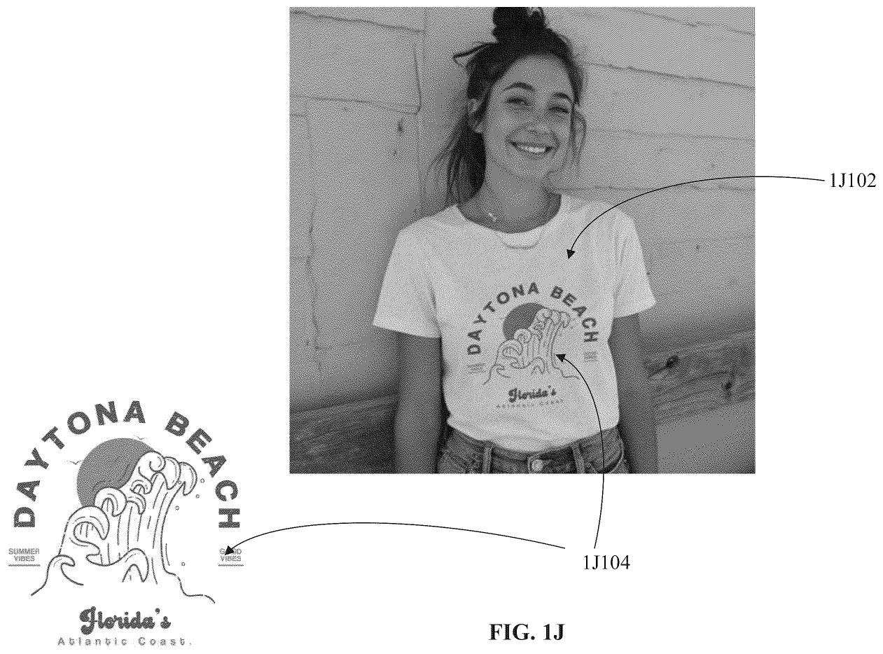

FIG. 1A is a block diagram showing an example environment 11 for the AI-based markup generation. Environment 11 depicted in FIG. 1A is configured to perform contextual resizing and filling in a design area. One of the elements of environment 11 is a computer collaboration system 100, described in detail later.

In some implementations, computer collaboration system 100 comprises a visualization service 100A, comprising a request generator 152, an image requestor 158, an image superimposer 160, and a rendering framework 130 (described in detail later). All components are described in detail later. Image requestor 158 may receive requests to generate a markup. Image superimposer 160 may be configured to superimpose a markup onto a customized product, as described later.

Collaboration system 100 may also include other components, examples of which are described later.

In some implementations, environment 11 also includes a database 172A storing key-value pairs (described later), a database 172B storing user profiles (described later), and one or more other databases 172N for storing additional information used by various components of environment 11 and/or computer collaboration system 100.

Environment 11 may also include a database 174A or a distributed or cloud-based system that can be used as storage for, e.g., billions of digital images of publicly available digital images. Such images may be downloaded from public resources, databases, and other repositories. For example, the images may be downloaded from the Internet and represent part of the DALL-E system (described later).

Images stored in database 174A or some other storage included in environment 11 may be used by an AI-based image generator 180. AI-based image generator 180 may be an AI-based application configured to, for example, implement the stable diffusion approach for generating markup images or synthesizing images in response to a textual query.

### 5.0. Generating Products with Markups

According to the present approach, customized products and markups may be generated using various generative AI approaches, such as Stable Diffusion. Other Gen-AI-based approaches may also be used.

FIG. 1B depicts examples of markups applied to example custom products. The depicted examples include a shirt 1B102 with a markup 1B104, a shirt 1B106 with a markup 1B108, a mug 1B110 with a markup 1B112, and a shirt 1B114 with a markup 1B116.

Markup 1B104 is a yellow rectangle. Markup 1B108 is a yellow checkerboard. Markup 1B112 is a yellow rectangle. Markup 1B116 is a yellow and magenta checkerboard. While the depicted markups are rectangular, other shapes of markups can also be used. Furthermore, additional colors may also be used.

The images with the markups may be generated by issuing a prompt as input to a GenAI application. An example prompt may include “a studio-quality photograph of a woman wearing a white t-shirt with a large yellow and magenta checkerboard printed on it.” Another prompt example may include “a studio quality photograph of an 11 oz white mug with a large yellow rectangle printed on it.”

### 6.0. Conforming Markup Areas to Layout Specifications

In some embodiments, a combined generated product and markup area are validated against a physical printed sample to ensure that it accurately reflects the dimensions defined in the layout specified for the product. The validation ensures that the generated product and markup accurately represent the physical product according to the specification.

FIG. 1C depicts an example of conforming a markup area to a layout specification. The depicted example shows that a markup 1C104 is applied to a t-shirt 1C102. The application of markup 1C104 to t-shirt 1C102 is then validated to ensure that the resulting product with the markup accurately represents a physical product according to the provided specification.

### 7.0. Finding a Markup

Once the location of a markup image applied to a custom product conforms to a provided specification, the location of the markup is determined, and the markup is separated from the custom product. An example process to separate the markup from the custom product may include various techniques, such as color or instance segmentation, using Mask R-CNN.

FIG. 1D depicts an example of finding a markup. In the depicted example, a markup 1D104 is applied to a custom t-shirt 1D102. Once it is determined that markup 1D104 is applied to custom t-shirt 1D102 according to the provided specification, markup 1D104 is separated from custom t-shirt 1D102. For example, the separation may be performed by segmenting markup 1D102 using color segmentation, including separating the yellow pixels of markup 1D102 from other pixels, including the white pixels of custom t-shirt 1D104.

### 8.0. Background Segmentation Example

In addition to segmenting or separating markup from a custom product in a picture, the segmentation process may also be applied to isolate the custom product from a background depicted in the image.

FIG. 1E depicts a segmentation example. In this example, the image is segmented into two parts: a custom product with a markup 1E104 from a background 1E102.

### 9.0. Removing Markups

An example process for removing a markup usually starts with determining a mask covering the markup. The mask of the markup region is generally included in the selection of the markup. A technique such as inpainting or generative fill may be used to remove the markup while leaving the contour of the product intact. This may become the base layer that other layers are composited on top of.

FIG. 1F depicts a markup removal example. In the example, a markup in a custom t-shirt 1F102 has been removed. The corresponding markup region is shown as a markup layer 1F104.

### 10.0. Generating a Grid

In the next step, a rectangular grid is generated based on a markup region obtained by removing a markup from a depiction of the custom product. In some implementations, a function (mFlowInterpQuadFromAlpha) is used to conform a rectangular grid to the space defined by the outer extents of the markup region. The mesh can then be used as a target to conform input images and subdivided to accommodate multiple areas, such as the pocket area for a t-shirt.

FIG. 1G depicts an example of generating a rectangular grid. In the depicted example, the markup region has been converted to a rectangular grid 1G102. In this particular example, grid 1G102, which has a front area 1G104, is subdivided into various areas, including a packet area 1G106. In some embodiments, grid 1G102 is represented as a 2D grid, while in others, grid 1G102 is represented as a 3D grid.

### 11.0. Depth Estimation

FIG. 1H depicts an example of depth estimation. The illustrated example shows two images: a left image, 1H102, and a right image, 1H104. Left image 1H102 is an image in which a depth map was calculated using MiDaS, Marigold, or similar depth estimation from a single input image. This depth map is used to assist with image segmentation and to conform the mesh to the contour of the product.

Right image 1H104 is a normal map that can be used with the depth map where certain features require more isolation.

### 12.0. Isolating Luminance and Specular Light

In the next step, luminance and specular light are isolated in the grid image. FIG. 1I depicts an isolation example. The depicted example illustrates the results of executing an isolation process on a markup region mask to isolate the corresponding custom product's luminance and generate specular overlay lighting effects to blend on the top of a middle mesh layer.

More specifically, FIG. 1I shows a specular overlay 11102, a mesh 11104, and a luminance map 11106.

### 13.0. Generating Dynamic Composite Images

The next step combines a base image and the corresponding layers into a resulting image. The resulting image comprises a mesh layer as input via a key-value pair to facilitate the insertion of design images that conform to a 3D space defined by the mesh.

It should be noted that the application of a design image onto a custom product is performed in such a way that the applied design image follows the curvature of the surface of the custom product, such as wrinkles in the custom product, depressions in the custom product, and the like.

FIG. 1J depicts a process of generating a dynamic composite image. In the depicted example, a design image 1J104 is applied onto the rectangular grid determined and isolated in a t-shirt 1J102. The determination and isolation of the rectangular grid were described above.

The depicted example depicts a simple application of an example design onto an example custom product. In other examples, the applications may be more complex. For example, they may include the applications of several design images onto several areas of the custom object.

### 14.0. Example System Specification

An example system specification described herein includes definitions of system characteristics and parameters. One of them provides custom product description key-value pairs. As described later, the key-value pairs define various characteristics and elements of a custom product and the customization process. For example, some key-value pairs (described later) may define layout elements, such as product attributes (e.g., a size defined using a manufacturer's size notation, a physical measurement for a lay-down, physical measurements in use, and the like).

The layout elements may also define customized areas, including a process type and the like. The process types may include, for example, a color profile, optical characteristics (e.g., layering, diffuse and specular reflectance, etc.), and the like.

The layer elements may also include size definitions, physical measurements, and visible area definitions (for manufacturing, lay-down, and in-use (such as a proportion of a visible product to the visible area). The size definition may also include definitions of bleed areas and the like.

The customized area parameters may also include the definitions of product placements, such as physical measurements obtained from, for example, product landmarks and the like.

In addition to the layout elements, the key-value pairs may include descriptive phrases, such as typical environments for, for example, marketing uses, typical users for marketing uses, blocking descriptors, lighting descriptors, product descriptive phrases, and markup descriptive phrases.

Examples of typical environments for marketing uses may include definitions of places, activities, and the like. An example prompt for “Urban Rooftop Vibes” may generate a capture of the essence of city living by showcasing models against the backdrop of a sunlit rooftop with towering skyscrapers and expansive skyline views in the distance, creating a blend of street style and high fashion energy.

Descriptive phrases may also include definitions of typical users for marketing purposes. That may include socio-cultural descriptors, cosmetic descriptors, age-gender descriptors, and the like. An example prompt for “Athletic and empowered may include “a strong, fit model with a toned physique and dynamic movements, embodying an active lifestyle. Whether mid-action or in still poses, their presence conveys determination, strength, and vitality.”

Descriptive phrases may also include definitions of blocking descriptors. Example prompts may include “over-the-shoulder-gaze,” and “block the model with their back to the camera, subtly turning their head for an over-the-shoulder look.”

Descriptive phrases may further include definitions of lighting descriptors, such as a light direction, a light type (e.g., sunlight (morning, daylight, evening, seasonal), artificial (e.g., stage, portrait, location), light geometry (e.g., point sources, spot, fill light), and the like. An example prompt for “high-key lighting” may include “create a bright, airy atmosphere with minimal shadows, where the subject is illuminated with evenly distributed soft light, set against a predominantly white or light-color background.”

Descriptive phrases may also include product descriptive phrases such as defining phrases, sizing phrases, attribute phrases (e.g., color, surface), and the like. Those descriptors can be specified as a purely generative prompt or pulled directly from the keys and values of the products themselves. Some examples from product data may include “an 11 oz white ceramic mug” or “a woman's white crew neck tri-blend t-shirt.”

Descriptive phrases may also include markup descriptive phrases. Example prompts may include “a yellow rectangle printed on the front of the product” and “a yellow and magenta checkerboard printed on the front of the product.”

An example system specification described herein may also include definitions of custom product imagery. They may include definitions of previous images with markup of known products. They may include metrics from digital assets, such as view orientation of product, placement of design areas, coverage of design areas, ratio of visible product to design area, and the like.

An example system specification described herein may also include definitions of generative image creation. That may include inputs for generative creation, such as textual input (user of descriptive phrases from product description, use of descriptive phrases to generative markup) and image input (use of custom product imagery, use of custom product imagery examples to generate markup).

An example system specification described herein may also include definitions of markup processing, such as segmentation, layout detection (including quadrilateral grid interpolation and quadrilateral grid fitting), and image synthesis.

An example system specification described herein may also include definitions of generative image evaluation, including comparisons of markup metrics from a generated image with metrics from custom product imagery (including a comparison placement, a comparison coverage ratio, and a lighting comparison).

An example system specification described herein may also include definitions of generative image correction, including definitions of adjustment of markup (such as adjustment by resampling quadrilateral grid, extensions of markup by extrapolation of the quadrilateral grid, and repositioning by resampling of the quadrilateral grid), and adjustment by modification of descriptive phrases to generate markups (including use phrases dictionary for size adjustment, and use phrases dictionary for placement adjustment).

An example system specification described herein may also include definitions of generative image embedding in interactive custom product assets, including generative images with markups processed like photographic imagery with markups.

An example system specification described herein may also include definitions of manufacturing interactive custom product assets based on a user's choice of customizable key-value pairs in the product description.

An example system specification described herein may also include definitions of correction of custom product descriptive phrases, including comparisons of generative images with physical products and adjustments of custom product descriptive phrases.

### 15.0. Generating Synthetic Images Using AI

### 15.1. Requests

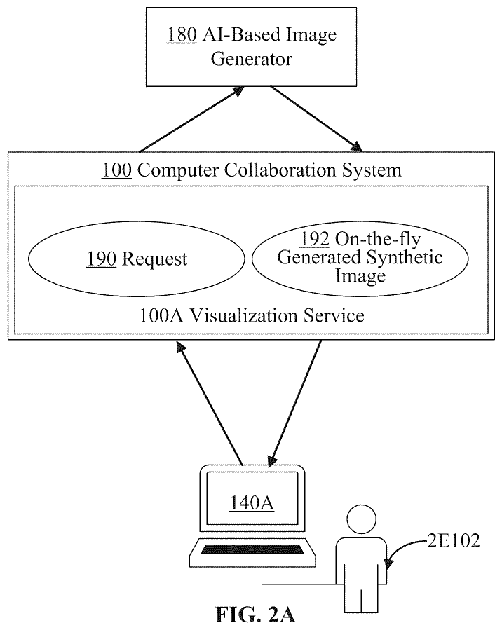

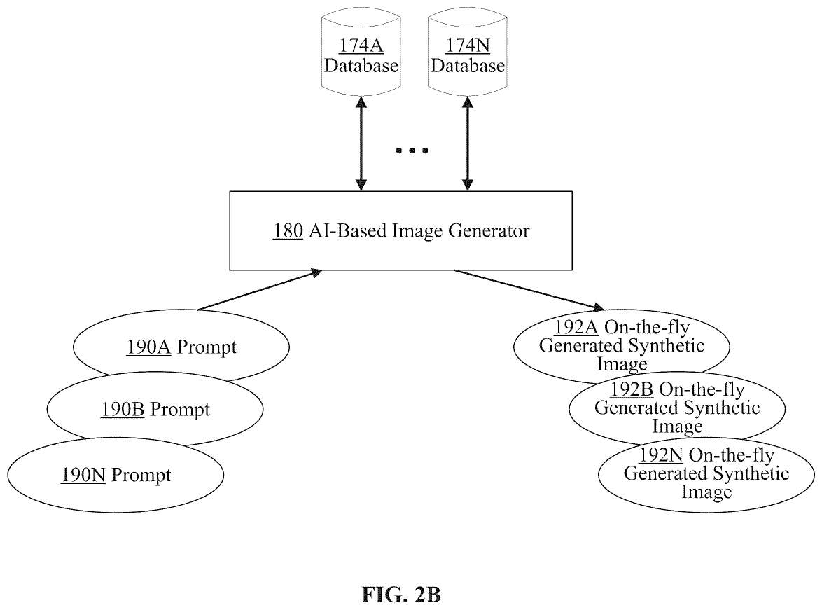

FIG. 2A is an example of utilizing an AI-based image generation approach. In the depicted example, synthetic images may be generated as a product of collaboration between computer collaboration system 100, AI-based image generator 180, a user 2E102 operating a user computer 140A.

In some embodiments, computer collaboration system 100 uses its visualization service 100A to communicate with AI-based image generator 180.

User computer 140A may receive customization requests from user 2E102, selections of custom products, and other requests to computer collaboration system 100. User computer 140A may also be used to display graphical visualization of custom products, including the visualization of on-the-fly generated AI-based images that have been merged with or incorporated into the visualization of the custom products.

Computer collaboration system 100 (or its visualization service 100A) may receive a graphical representation of a custom digital product, such as a mug product, a t-shirt, and the like. The graphical representation for a product may include encoded information about the product and the product description-including the key-value pairs described later.

In some embodiments, a graphical representation of the custom digital product comprises product description data for a custom digital product. The product description data comprise a plurality of parameters of the custom digital product, and each parameter of the custom product is a key-value pair. A key-value pair is a data structure that includes an attribute key and a corresponding attribute value.

Based on the received product description and the user's profile, events, and the like, visualization service 100A determines one or more regions within the depiction of the custom product. The regions may be customized when displaying the graphical representation of the custom digital product on a display device.

A region may be a markup region described above. It may be determined based on the information included in the graphical representation of the product, the key-value pairs, a user's profile, and the like. The regions may include the background to be shown behind a depiction of the product or other regions to be displayed behind a depiction (or depictions) of the product or within the depiction of the product.

For each region, visualization service 100A determines a set of keywords/phrases specific to the custom digital product and the customization of the custom digital product. The phrases may include one or more key-value pairs extracted from the product description data. The phrases may also include one or more pieces of information extracted from a user profile of a user who customized the custom digital product. The set of phrases may further include one or more pieces of information extracted from a repository of events associated with the custom digital product.

For each region, the corresponding keywords/phrases may be used to create a prompt corresponding to request 190.

A prompt may be a textual request and may pertain to a synthetic image generation request. It is possible to generate several requests for one region.

All the requests may be transmitted by visualization service 100A to an AI-based image generator.

### 15.2. AI-Based Image Generator

AI-based image generator 180 is configured to receive requests for synthetic images, generate synthetic images in response to receiving the requests, and provide the generated synthetic images to visualization service 200A.

FIG. 2B is an example of an AI-based image generator. An AI-based image generator 180 may receive a plurality of prompts 190A, 190B . . . 190N. The prompts may pertain to a markup region within a customization image.

AI-based image generator 180 may be configured to access one or more databases, such as database 174A-174N. A database may store image repositories, training data, training models, learning models, and the like.

In response to receiving prompts 190A-190N, AI-based image generator 180 may generate one or more on-the-fly generated synthetic images 190A-190N.

### 15.3. Synthetic Images

Synthetic images may be generated based on the keywords/phrases included in the corresponding prompts. For each prompt, one or more synthetic images may be generated. As described before, each on-the-fly synthetic image is synthesized and generated from one or more images retrieved from database(s) 174A-174N. Therefore, none of the synthetic images 190A-190N looks like any of those stored in the repository.

For each prompt 190, upon receiving the request, AI-based image generator 180 generates a customized synthetic image based on, at least in part, the prompt and a repository of images, as described earlier. The customized synthetic image is not a copy of any image from the repository of images. Instead, the customized synthetic image is generated by synthesizing a set of images that an AI-based image generator selected from the repository of images and by synthesizing the selected images.

Referring again to FIG. 2A, once the customized synthetic images are generated by AI-based image generator 180, the generator transmits the images to the computer collaboration system 100, and the virtualization service stores the images as on-the-fly generated synthetic images 192.

Upon receiving on-the-fly generated synthetic images 192, visualization service 100A matches the received images with the corresponding regions, includes the images in the corresponding regions, and generates a graphical visualization of the custom product and the corresponding synthetic images.

Then, visualization service 100A displays, on the display device, the graphical visualization of the custom digital product along with the customized synthetic images in the corresponding regions.

The graphical visualization and the graphical representation of the custom digital product may be transmitted or otherwise provided to a manufacturing product rendering unit of a manufacturing entity. The manufacturing product rendering unit may render the graphical visualization and representation of the custom digital product and, for example, print, using printing instructions of a manufacturing product rendering unit, the graphical representation of the custom digital product to generate a physical representation of the custom digital product.

### 16.0. Quadrilateral Interpolation Approach

In some implementations, a markup region is interpolated using a quadrilateral grid and an image's alpha channel. An alpha channel represents the degree of opacity (also defined as transparency) of a computer-generated image, video footage, or the bump, displacement, or opacity properties of a 3D texture. Alpha compositing or alpha blending is the process of combining one image with a background to create the appearance of partial or full transparency.

An interpolation process using a quadrilateral grid and alpha channel may include the following steps:
1) As input:
   a) Take an image with an alpha channel showing a rectangle mapped onto a 3D surface, such as a T-shirt, towel, or drape.
   b) Take the number of rows and columns needed to construct a quadrilateral grid.
2) Vectorize the shape found in the alpha channel.
   a) Use uniform distance sampling.
   b) Each point on the path is roughly equidistant from its neighboring points.
3) Determine the corners of the vector path.
   a) Find the centroid of the path by averaging the vector path points.
   b) Find the farthest point from the centroid, this is v0.
   c) Find the farthest point from the first corner, this is the v2.
   d) Find the positive farthest point from the line v0-v2, this is v1.
   e) Find the negative farthest point from the line v0-v2, this is v3.
      i) The corners are points v0, v1, v2, v3 in winding order.
4) Correct the winding order of the vector path so it is clockwise.
   a) If the surface normal of the poly v0, v1, v2, v3 is negative, reverse the order of the points.
5) Correct the orientation of the poly.
   a) Rotate the point order so the v0 is closest to the upper left corner of the image frame.
6) Set each sub-path of the quadrilateral grid using the found corners.
   a) Top is Sub path v0-v1.
   b) The Right Side is Sub path v1-v2.
   c) Bottom is Sub path v3-v2.
   d) The Left Side is Sub path v0-v3.
7) Resample the Sub paths.
   a) Resample sub path v0-v1, and v3-v2 to have the input number of columns.
   b) Resample sub paths v1-v2 and v0-v3 to have the input number of rows.
8) Sample the quadrilateral grid:
   a) For each u, v element in the column by row numbered grid.
      i) Calculate the element's v interpolant (vi):
         (1) Interpolate between v0-v1 [u] and v0-v1 [u] by v/rows.
      ii) Calculate the element's U interpolant (ui):
         (1) Interpolate between v1-v2 [v] and v0-v3 [v] by u/columns.
   b) Determine the weight for the u element (uw).
      i) Let i=v/rows.
      ii) Let uw=power(i, 3)+power(1-i, 3).
   c) Determine the weight for the v element (vw).
      i) Let i=u/columns.
      ii) Let vw=power (i, 3)+power (1-i, 3).
   d) Weight and set the u, v element:
      i) Element u,v=((uw*ui)+(vw*vi))/(uw+vw).
   e) Note that this adjusts the interpolated values of each element by the distance from the contributing edges.

TABLE 1 below is a graph showing the weight contribution (the vertical axis) based on the position of a value in the mesh (the horizontal axis) positions 1 through 11.

Note that on either side of the mesh (i.e., positions 1 and 11), the value of the mesh at that position fully contributes.

### 17.0. Example Computer Environments

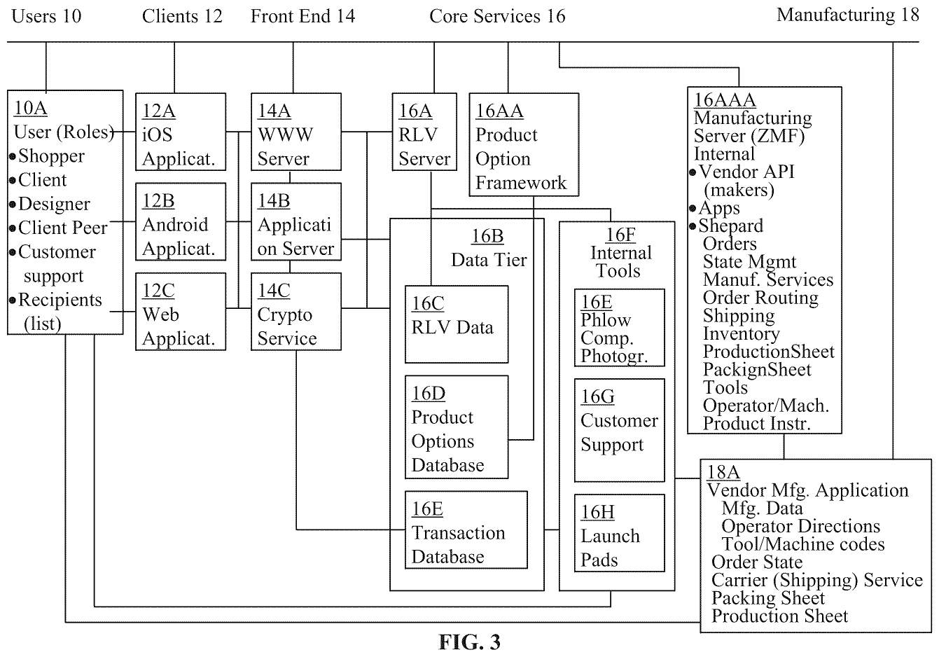

In some embodiments, the presented approach is implemented in a computer-based platform. The platform allows users, designers, customers, and support engineers to, for example, design and create digital product designs. FIG. 3 describes a computer environment for creating digital designs, manufacturing products, and the like.

A digital design for a product may be captured in, for example, product description data. A hyperlink to the particular location may be created and transmitted from the collaboration platform to a manufacturing server to cause the manufacturing server to generate a final product based on the digital design.

A product may be digital, such as a digital gift card, or physical or digital, such as a physical or digital t-shirt.

FIG. 3 is a block diagram showing an example computer environment. In FIG. 3, users 10 are individuals who create and design digital designs of products; clients 12 correspond to software applications configured to facilitate communications between users 10 and front-end servers 14; core services 16 correspond to software applications and tools configured to facilitate creating and designing of the digital designs and generating manufacturing instructions for manufacturing final products based on the digital designs; and manufacturing 18 corresponds to manufacturing servers and applications configured to manufacture, or cause manufacturing, the final products, and the like.

Each user 10 may use its own or shared computer device. In some embodiments, examples of user 10 are determined based on the roles that may be assigned to the users. Examples 10A of roles may include a shopper, a client, a designer, a client peer, a customer support engineer, a recipient, and the like.

Clients 12 in FIG. 3 refer to client applications implemented in client servers 14 and configured to support requests received from users 10A. Non-limiting examples of clients 12 may include iOS applications 12A, Android applications 12B, Web applications 12C, and the like.

Front and end servers 14 refer to computer-based servers configured to process requests received from clients 12 and, in many cases, interact with core services 16 to resolve these requests further. Examples of front-end servers 14 include one or more WWW servers 14A, one or more application servers 14B, and one or more cryptographic servers 14C. Cryptographic servers 14C may be configured to provide cryptographic services for encrypting/decrypting, transmitting, or otherwise communicating data between the entities depicted in FIG. 1.

Core services 16 in FIG. 3 refer to servers and services implemented in a role-based collaboration platform configured to provide functionalities for creating and designing digital designs, handle collaboration requests, and facilitate the customization requests received from users 10.

In some embodiments, a customization process performed by a user of users 10, intended to generate a digital design of a customized product, is captured in so-called product description data, which may be translated into a manufacturing description comprising product and manufacturing instructions.

The product and manufacturing instructions may include digital design specifications, data, and code needed to manufacture a custom product. That may include instructions for generating, for example, a 3D geometry for digital final products. This may also include generating instructions for generating 2D and 3D patterns that may be used to cut, cast, or form physical or digital components of physical or digital final products. The patterns may be parametric, i.e., they may have parameters that, through encoded relationships, adjust the form of the pattern for a specific need.

For instance, a set of 2D patterns for a t-shirt graded based on size may become a parametric pattern by interpolating grade curvatures. A single parametric value, usually called a ‘size,’ may set the automatic grading.

The product instructions may also include 2D and 3D models used to form, through additive manufacturing or subtractive manufacturing, portions of a product. The models may be parametric, i.e., they may have parameters that, through coded relationships, adjust the form of the model for a specific need. For instance, a set of 3D models may represent a bike helmet. Each model may fit a statistically normed human head of a particular age. A coded relationship between the models may allow for interpolating the set of models for a specific age. A single parametric value may set the automatic interpolation. The single parametric value, in this case, is usually called an ‘age.’

The product instructions may also include material properties, such as the physical or digital material used to form a product from a pattern. Some material properties may be parametric, i.e., they may be selected or changed during manufacturing.

The properties may also include a body color. For instance, the color of a fabric may be selected for manufacturing a t-shirt. According to another example, the plastic color may be chosen for manufacturing a bike helmet.

The properties may also include a body texture, such as the fabric weave of a t-shirt, which may be specified to be smooth or slubby. For instance, the surface of a plastic bike helmet may be polished or satin. Each property is necessarily specific to each class of materials. Examples of materials and properties may include a fabric (such as a weave or knit type, a fiber type (e.g., cotton, wool, flax, polyester, polypropylene), a thread size, a thread count, a color, an integral design (e.g., ikat, knit, tapestry, etc.), a bolt width, a selvage type, a surface (e.g., hand), and the like.

Referring again to FIG. 3, in some embodiments, core services 16 refer to services implemented in a role-based collaboration platform. In the example, core services 16 may be provided by one or more real-view (RLV) servers 16A and a product option framework 16AA. RLV servers 16A and product options framework 16AA may use one or more data tier databases 16B, including RLV Data 16C, a product options database 16D, a transaction database 16E, and the like.

In some embodiments, core services 16 may also utilize internal tools 16F, such as computational photographic tools 16E, customer support tools 16G, launch pads tools 16H, etc.

Product option framework 16AA is also called a persistent design data framework. The framework data may include a product options set, which may include a set of product options pertaining to a specific product type. It usually contains the product instructions (e.g., collaboration components 106 in FIG. 2) for manufacturing or producing the product.

In some embodiments, product options framework 16AA is configured to provide services for transforming ProductOption key/value pairs (i.e., manufacturing constraints) from one product to the other. Transforming the ProductOption key/value pairs from one product to another may require, for example, transforming the color space (i.e., sRGB to CMYK US Web Coated (SWOP) v2), transforming an image from raster to vector, and resizing the image for the fit.

In some embodiments, the product option set contains the logic to enumerate each customizable option in a manner that presents a complete user interface to change the parametric product instructions.

The instructions for manufacturing a customized product are usually parametric. The parameters include the size of the customized product (this can be multi-dimensional and include width, height, and depth). The parameters may also relate to human size or age. The parameters may also be custom and based on biometric information.

A product option may be represented as a key/value pair in some embodiments. The key/value pair is a label that may span individual products and represent a class of products. The keys of pairs may include a material type, a color, a size, and the like.

The value in a key/value pair is a specific discrete or continuous value that sets a manufacturing instruction. Examples of discrete (enumerated) values may include a discrete type of fabric such as cotton, cotton-polyester blend, silk, and the like. The discrete values may also include specific colors, such as white, navy, black, and the like.

Examples of continuous values of key/value pairs may include a single element, such as length or a ribbon, a vector, such as the size of a frame for a print (width (in inches) or height (in inches)), or the size of a box for the European countries, such as a size of a box for the EU (width (in millimeters), height (in millimeters), depth (in millimeters)).

The values may also reference a known file type, such as an image for the t-shirt design, an embroidery file for the back of a jacket, an engraving design for a bracelet, and the like.

In some embodiments, values in key/value pairs may include a set of graphic primitives for a design, such as an image, a line, a circle, a rectangle, a text, a group, and the like.

The product option key values may have default values. Default values are pre-set values that will produce a product without changing any key/value pairs through customization. When key values are changed, they may produce a product option framework event chain. A product options framework event chain is a journal of each key-value change ordered in time.

A product option key-value may represent a product type. Using this option type, one product type may be associated with another through a well-known relationship.

In some embodiments, a product options framework event chain includes one or more products, and the chain may represent or memorialize an event. The products may represent or memorialize an event. Examples of events may include weddings, birthdays, anniversaries, graduations, national holidays, reunions, and the like.

In some embodiments, in a product option set event chain, a key/value pair encodes the following product in the chain. For example, an invitation may be chained to an RSVP card. A key-value may also encode the role of the chained event. For example, a chained RSVP card key-value may include a recipient of the invitation as the sender role for the RSVP card.

A key-value pair may also encode the shared properties used to set the chained product's properties. For instance, a design for the invitation may be shared with the RSVP card. A key-value may also encode the timing for the chained product. Typically, the event chain properties are custom (e.g., parametric), and a product designer may change them to fit a specific product set.

In an embodiment, a product option framework is configured to generate a product option framework user interface. Accordingly, each product option set is associated with logic and code to build a user interface element for each parametric product option. Furthermore, each product options set contains style hints so that each user interface element may be artfully placed to produce a high-quality user experience.

Typically, user interface elements are designed to match each class of values in all products covered by a product options framework. New user interface elements may be added as the product categories expand. The user interface elements may include a design view, a color editor, a font editor, a size selector, a texture selector, a text editor, a fabric swatch selector, a product configurable image, and the like.

In some embodiments, a product options framework cooperates with a user product renderer that may be implemented in, for example, a RealView server 16A. The user product renderer may be configured to render views of a custom product as it is already manufactured. Typically, it uses a product option set of key-values as input. It creates one or more run-time assets using computational photography of the manufactured product.

### 18.0. Generating and Refining Synthetic Images of Customizable Products

### 18.1. Overview

In some implementations, a core service receives a text prompt describing a product and a desired markup, generating a synthetic image of the product with the markup using a generative AI system, validating the synthetic image against physical product specifications to ensure conformity; mapping the synthetic image onto a 3D surface using quadrilateral grid interpolation; applying inpainting techniques to remove the markup while preserving underlying fabric details; incorporating lighting and specular effects to enhance the realism of the synthetic image; integrating the enhanced synthetic image into an interactive asset for customizable product visualization; providing the interactive asset for user interaction and customization before manufacturing.

Another aspect of the method is that it comprises text prompts with specific product attributes such as color, size, or material.

The method comprises the generative AI system utilizing different AI models for generating synthetic images.

Another aspect of the method is comparing the synthetic image with a database of physical product specifications for validation.

According to another aspect, the method comprises mapping the synthetic image onto a 3D surface employing alternative interpolation methods.

According to another aspect, the method comprises the inpainting techniques using texture synthesis algorithms to preserve additional product details.

According to another aspect, the method further simulates various lighting scenarios, such as natural or artificial light, to enhance realism.

According to another aspect, the method comprises the interactive asset enabling real-time customization of the synthetic image.

In another aspect, the method allows users to modify product features directly within the interactive asset.

According to another aspect, an apparatus for generating and refining synthetic images of customizable products comprises a generative AI system configured to create synthetic images with digital markups based on user inputs; a validation and correction module configured to validate and correct the synthetic images to ensure conformity with physical product specifications; a 3D mapping and image synthesis module configured to map user images onto 3D surfaces using quadrilateral grid interpolation; an inpainting module configured to remove digital markups from the synthetic images while preserving underlying fabric details; an interactive asset creation system configured to integrate the synthetic images into interactive assets for customizable product visualization and manufacturing; depth estimation and normal mapping tools configured to refine a placement and appearance of digital markups on 3D models; a lighting and specular effects module configured to apply lighting and specular effects to enhance the realism of the synthetic images.

In another aspect, the apparatus comprises the generative AI system, which is further configured to accept text and image inputs for enhanced customization.

The apparatus comprises the generative AI system configured to generate multiple design variations for user selection.

The apparatus further comprises the validation and correction module, incorporating machine learning algorithms to improve accuracy over time.

The apparatus also comprises the validation and correction module, which provides a report of discrepancies between synthetic and physical specifications.

Another aspect of the apparatus is that it comprises the 3D mapping and image synthesis module, utilizing alternative interpolation methods for different surface types, such as spline interpolation.

In another aspect, the apparatus comprises the 3D mapping and image synthesis module, which supports multiple file formats for compatibility with different design software.

Furthermore, the apparatus comprises the inpainting module employing advanced texture synthesis techniques to maintain fabric continuity.

The apparatus also comprises the inpainting module, which offers customizable inpainting parameters for user-defined detail preservation.

According to yet another aspect, a non-transitory, computer-readable storage medium storing one or more computer instructions which, when executed by one or more computer processors, cause the one or more computer processors to perform receiving a text prompt describing a product and a desired markup; generating a synthetic image of the product with the markup using a generative AI system; validating the synthetic image against physical product specifications to ensure conformity; mapping the synthetic image onto a 3D surface using quadrilateral grid interpolation; applying inpainting techniques to remove the markup while preserving underlying fabric details; incorporating lighting and specular effects to enhance the realism of the synthetic image; integrating the enhanced synthetic image into an interactive asset for customizable product visualization; providing the interactive asset for user interaction and customization prior to manufacturing.

### 18.2. Example Flow Chart for Generating and Refining Synthetic Images of Customizable Products

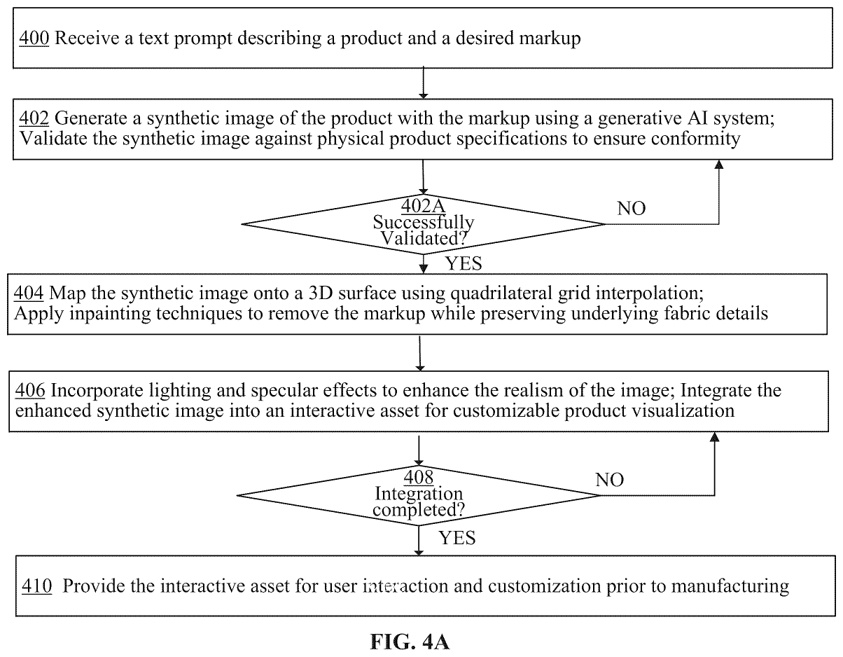

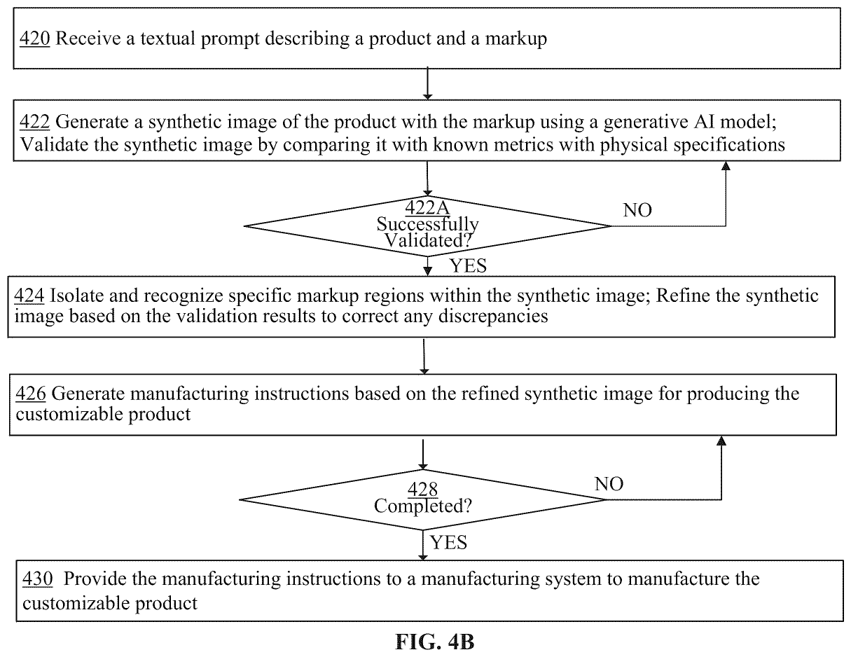

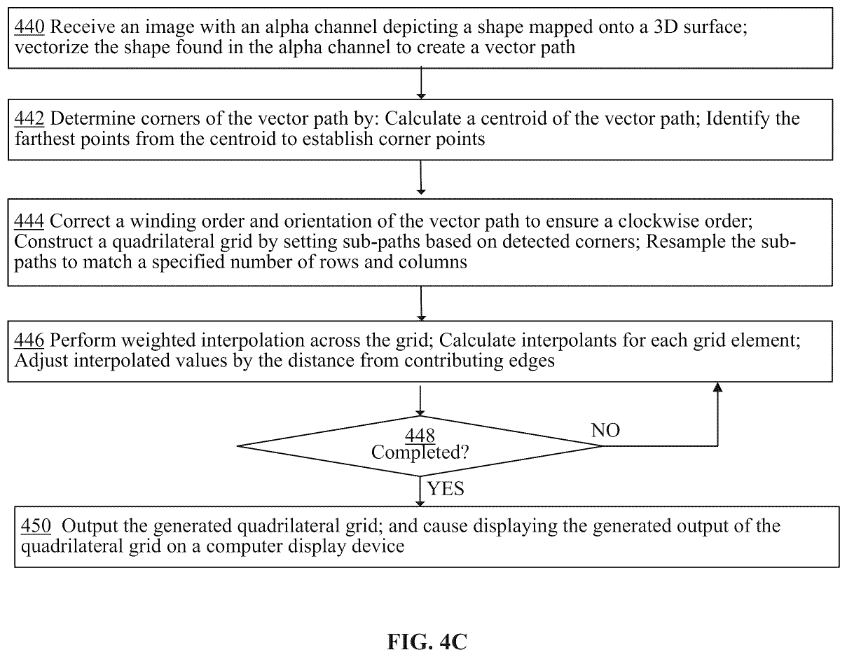

FIG. 4A is a flow chart depicting an example process for generating and refining synthetic images of customizable products. The example process described in FIG. 4A may be executed by one or more components of core services 16, described later. For simplicity of the description, it is assumed that the steps described in FIG. 4A are performed by a core service.

In step 400, a core service receives a text prompt describing a product and a desired markup. The text prompt may include specific product attributes such as color, size, or material.

In step 402, the core service generates a synthetic image of the product with the markup using a generative AI system. The generative AI system may utilize different AI models to generate synthetic images.

Also, in this step, the core service validates the synthetic image against physical product specifications to ensure conformity.

In step 402A, the core service tests whether the validation is successful, i.e., whether the synthetic image conforms to the physical product specifications. If it is, then the core service proceeds to step 404. Otherwise, the core service generates a new synthetic image and performs the validation of the new synthetic image against the physical product specification.

In step 404, the core service maps the synthetic image onto a 3D surface using quadrilateral grid interpolation. Mapping the synthetic image onto a 3D surface employs alternative interpolation methods in some embodiments.

Also, in this step, the core service applies inpainting techniques to remove the markup while preserving underlying fabric details. In some embodiments, the inpainting techniques use texture synthesis algorithms to preserve additional product details.

In step 406, the core service incorporates lighting and specular effects to enhance the realism of the synthetic image. Also, in this step, the core service integrates the enhanced synthetic image into an interactive asset for customizable product visualization. In some embodiments, the interactive asset enables real-time customization of the synthetic image.

In step 408, the core service checks whether integrating the enhanced synthetic image into the interactive asset for customizable product visualization has been completed. If it has, then the core service performs step 410. Otherwise, the core service repeats the step 406.

In step 410, the core service provides the interactive asset for user interaction and customization prior to manufacturing.

In some embodiments, the method comprises comparing the synthetic image with a database of physical product specifications for validation. The method further comprises simulating various lighting scenarios, such as natural or artificial light, to enhance realism. The method may also include allowing users to modify product features directly within the interactive asset.

### 19.0. Generating and Validating Digital Markups on Customizable Products

### 19.1. Overview

In some embodiments, a computer-implemented method for generating and validating digital markups on customizable products begins with a textual prompt describing the product and the desired markup. This prompt can be input through various user interfaces, such as a web application, a mobile app, or a voice-activated system, allowing for flexibility in how users interact with the system. The generative AI model, a neural network trained on a diverse dataset of customizable products, generates a synthetic image of the product with the specified markup. This model may utilize different generative AI techniques, including Generative Adversarial Networks (GANs) or transformer-based models, to create high-fidelity images.

In another embodiment, the synthetic image undergoes a validation process where the synthetic image is compared against known product metrics to ensure the synthetic image meets physical specifications. This validation can include checking the placement and size of the markup against predefined product dimensions, ensuring that the design is feasible for manufacturing. Advanced image segmentation techniques, such as deep learning-based methods, isolate and recognize specific markup regions within the synthetic image. This segmentation can support multi-layer designs, allowing for complex and detailed customizations.

The synthetic image is refined following validation to correct any discrepancies identified during the validation process. This refinement may involve adjusting the markup's color and position based on feedback from the validation step. The refined image is then normalized to match a standard color profile, ensuring consistency across viewing and manufacturing environments.

The method generates detailed manufacturing instructions based on the refined synthetic image in another embodiment. These instructions can specify various aspects of the production process, such as printing techniques, materials to be used, and other relevant parameters. The manufacturing instructions are then provided to a manufacturing system, such as a 3D printer, a CNC machine, or other suitable production equipment, to produce the customizable product. The refined synthetic image can also be displayed on a user interface for review before production, allowing users to make final adjustments or approve the design.

These embodiments demonstrate the system's adaptability within the legal and functional scope defined by the patent claims, showcasing the system's ability to handle various input methods, utilize advanced AI techniques, and integrate seamlessly with different manufacturing systems.

### 19.2. Example Flow Chart for Example Flow Chart for Generating and Validating Digital Markups on Customizable Products

FIG. 4B is a flow chart depicting an example process for generating and validating digital markups on customizable products. For simplicity of the description, it is assumed that the steps described in FIG. 4B is performed by a core service.

In step 420, a core service receives a textual prompt describing a product and a markup.

In step 422, the core service generates a synthetic image of the product with the markup using a generative AI model. In some embodiments, the generative AI model is a neural network trained on a dataset of customizable products.

Also, in this step, the core service validates the synthetic image by comparing it with known product metrics to ensure conformity with physical specifications. In some embodiments, the validation includes checking the placement and size of the markup against predefined product dimensions.

In step 422A, the core service tests whether the validation is successful, i.e., whether the synthetic image conforms to the physical product specifications. If it is, then the core service proceeds to step 424. Otherwise, the core service generates a new synthetic image and performs the validation of the new synthetic image against the physical product specification.

In step 424, the core service isolates and recognizes specific markup regions within the synthetic image.

Also, in this step, the core service refines the synthetic image based on the validation results to correct any discrepancies. In some embodiments, the refining involves adjusting the markup's color and position based on validation feedback.

In step 426, the core service generates manufacturing instructions based on the refined synthetic image for producing the customizable product. In some embodiments, the manufacturing instructions include details on printing techniques and materials to be used.

In step 428, the core service checks whether all necessary manufacturing instructions for producing the customizable product have been generated. If they have, then the core service proceeds to step 430. Otherwise, the core service repeats step 426.

In step 430, the core service provides the manufacturing instructions to a manufacturing system to manufacture the customizable product.

In some embodiments, the method further comprises normalizing the synthetic image to match a standard color profile before the validation. The method may also include image segmentation techniques to isolate the markup regions. Further, the method may include displaying the refined synthetic image on a user interface for review before production.

### 20.0. Generating a Quadrilateral Grid from an Image Alpha Channel

### 20.1. Overview

In one embodiment, a computer-implemented method for generating a quadrilateral grid from an image with an alpha channel involves receiving an image that depicts a shape mapped onto a 3D surface, where the image is processed to vectorize the shape found in the alpha channel, creating a vector path. The method then determines the corners of the vector path by calculating the centroid of the vector path and identifying the points from the centroid to establish corner points. The winding order and orientation of the vector path are corrected to ensure a clockwise order. A quadrilateral grid is constructed by setting sub-paths based on the detected corners, and these sub-paths are resampled to match a specified number of rows and columns. Weighted interpolation is performed across the grid by calculating interpolants for each grid element based on inverse square distance weighting and adjusting interpolated values by the distance from contributing edges. The generated quadrilateral grid is then outputted and displayed on a computer display device.

In other embodiments, the method includes normalizing the vector path to fit within a predefined coordinate system, ensuring that the shape is accurately represented regardless of the original dimensions or orientation. This normalization process allows for consistent grid generation across different images and shapes.

In a further embodiment, the vectorizing process includes smoothing the vector path using a spline interpolation, which enhances the accuracy and smoothness of the generated grid by reducing jagged edges and irregularities in the vector path.

Additionally, the centroid calculation can be performed by averaging the coordinates of the vector path's points, providing a simple yet effective method for determining the central point of the shape.

To verify the clockwise order, the method includes calculating the 3D surface's orientation of the quadrilateral, ensuring that the grid is correctly oriented in 3D space.

Resampling the sub-paths can involve linear interpolation to distribute points evenly, which helps maintain a uniform grid structure.

For enhanced accuracy, the weighted interpolation may use cubic weighting functions, providing more precise interpolant calculations than straightforward methods.

The generated quadrilateral grid can be displayed on a graphical user interface, allowing users to interact and manipulate the grid in real time. This embodiment highlights the method's adaptability and precision in generating accurate quadrilateral grids from images with alpha channels, suitable for various applications in computer graphics and 3D modeling.

20.2. Example Flow Chart for Generating a Quadrilateral Grid from an Image Alpha Channel

FIG. 4C is a flow chart depicting an example process for generating a quadrilateral grid from an image with an alpha channel. For simplicity of the description, it is assumed that the steps described in FIG. 4C is performed by a core service.

In step 440, a core service receives an image with an alpha channel depicting a shape mapped onto a 3D surface. Also, in this step, the core service vectorizes the shape found in the alpha channel to create a vector path. In some embodiments, the vectorizing includes smoothing the vector path using a spline interpolation.

In step 442, the core service determines the corners of the vector path by calculating a centroid of the vector path. In some embodiments, the centroid is calculated by averaging the coordinates of the vector path's points.

Also, in this step, the core service identifies the farthest points from the centroid to establish corner points.

In step 444, the core service corrects a winding order and orientation of the vector path to ensure a clockwise order. Also, in this step, the core service constructs a quadrilateral grid by setting sub-paths based on detected corners.

In this step, the core service also resamples the sub-paths to match a specified number of rows and columns. In some embodiments, resampling the sub-paths involves linear interpolation to distribute points evenly.

In step 446, the core service performs weighted interpolation across the grid by calculating interpolants for each grid element based on inverse square distance weighting. In some embodiments, the weighted interpolation uses cubic weighting functions for enhanced accuracy.

Also, in this step, the core service adjusts interpolated values by the distance from contributing edges.

In step 448, the core service checks if the distance from contributing edges has adjusted all interpolated values. If they have, then core service performs step 450. Otherwise, the core service repeats step 446.

In step 450, the core service outputs the generated quadrilateral grid. Also, in this step, the core service causes displaying the generated output of the quadrilateral grid on a computer display device.

In some embodiments, the method further comprises normalizing the vector path to fit within a predefined coordinate system. The method may also include verifying the clockwise order by calculating the 3D surface's normal of the quadrilateral. Furthermore, the method comprises displaying the generated quadrilateral grid on a graphical user interface.

### 21.0. Example Benefits of the Present Approach

The approach presented herein offers several significant benefits, such as enhancing the generating and refining of synthetic images of customizable products. More specifically, the benefits include cost and time efficiency. The present approach eliminates the need for physical prototypes and extensive photography sessions by utilizing generative AI to create synthetic images. This significantly reduces the time and cost associated with traditional product visualization and customization methods.

Another benefit includes the high accuracy and realism of the generated images. The validation and correction module ensures that synthetic images conform to physical product specifications, enhancing the accuracy and reliability of the generated images. The incorporation of lighting and specular effects, as well as advanced inpainting techniques, further enhances the realism of the synthetic images, making them visually indistinguishable from actual photographs.

Additional benefits include the flexibility and adaptability of the markup process. The system's ability to accept text and image inputs, utilize different AI models, and employ various interpolation methods allows for high flexibility and adaptability in generating markups. This ensures the system can handle multiple product types, shapes, and customization requirements, catering to diverse user needs.

The benefits further comprise real-time customization: Integrating synthetic images into interactive assets enables users to customize in real time. This interactive feature lets users modify product features directly, providing a highly engaging and personalized experience. Users can immediately see the effects of their customizations, ensuring that the final product meets their specifications.

Additional benefits include enhanced user experience. The system's ability to generate multiple design variations and offer customizable inpainting parameters provides users with a wide range of options and greater control over the final appearance of their products. This enhances the overall user experience, leading to higher satisfaction and better-informed purchasing decisions.

The benefits also include continuous improvement in the markup-generating process. Incorporating machine learning algorithms in the validation and correction module allows the system to improve its accuracy continuously over time. Learning from past corrections and user feedback makes the system more reliable and effective in generating high-quality synthetic images.

The system also includes seamless integration. The system's ability to integrate synthetic images into existing workflows and processes ensures seamless adoption and implementation. The generated images can be used in various applications, such as online product configurators, marketing materials, and virtual try-on experiences, enhancing product customization, visualization efficiency, and effectiveness.

The approach also offers reduced environmental impact. The approach reduces resource consumption and waste by eliminating the need for physical prototypes and reducing reliance on traditional photography. This environmentally friendly approach aligns with sustainable business practices and helps reduce the overall environmental impact of product customization processes.

Overall, the present approach offers a comprehensive and technologically advanced solution for generating and refining synthetic images of customizable products, providing significant benefits in cost efficiency, accuracy, flexibility, user experience, and environmental sustainability.

### 22.0. Implementation Mechanisms

Although the flow diagrams of the present application depict a particular set of steps in a specific order, other implementations may use fewer or more steps in the same or different order than those shown in the figures.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques under program instructions in firmware, memory, other storage, or a combination. Such special-purpose computing devices may combine custom hard-wired logic, ASICs, or FPGAs with custom programming to accomplish the techniques. The special-purpose computing devices may be desktop computer systems, portable computer systems, handheld devices, networking devices, or any other device that incorporates hard-wired and program logic to implement the techniques.

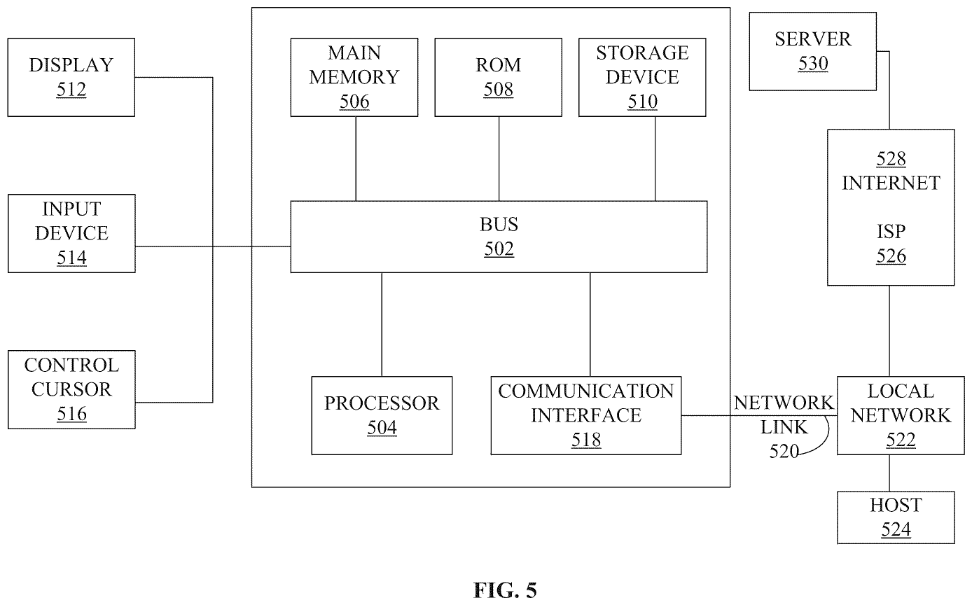

FIG. 5 is a block diagram that depicts an example computer system 500 upon which embodiments may be implemented. Computer system 500 includes a bus 502 or other communication mechanism for communicating information and a processor 504 coupled with bus 502 for processing information. Computer system 500 also includes a main memory 506, such as a random-access memory (RAM) or other dynamic storage device, coupled to bus 502 for storing information and instructions to be executed by processor 504. Main memory 506 may also be used to store temporary variables or other intermediate information during the execution of instructions to be executed by processor 504. Computer system 500 includes a read-only memory (ROM) 508 or other static storage device coupled with bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. Although bus 502 is illustrated as a single bus, bus 502 may comprise one or more buses. For example, bus 502 may include, without limitation, a control bus by which processor 504 controls other devices within computer system 500, an address bus by which processor 504 specifies memory locations of instructions for execution, or any other type of bus for transferring data or signals between components of computer system 500.

An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic, or computer software which, in combination with the computer system, causes or programs computer system 500 to be a special-purpose machine. According to one embodiment, those techniques are performed by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the embodiments. Thus, embodiments are not limited to any specific combination of hardware circuitry and software.

The term “computer-readable medium” refers to any medium that provides data that causes a computer to operate in a specific manner. In an embodiment implemented using computer system 500, various computer-readable media are involved, such as providing instructions to processor 504 for execution. Such a medium may take many forms, including, but not limited to, non-volatile media and volatile media. Non-volatile media includes, for example, optical or magnetic disks, such as storage device 510. Volatile media includes dynamic memory, such as main memory 506. Typical forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip, or memory cartridge, or any other medium from which a computer can read.

Various forms of computer-readable media may be involved in carrying one or more sequences of one or more instructions to processor 504 for execution. For example, the instructions may initially be carried on a magnetic disk of a remote computer. The remote computer can load the instructions into its dynamic memory and send them over a telephone line using a modem. A modem local to computer system 500 can receive the data on the telephone line and use an infrared transmitter to convert the data to an infrared signal. An infra-red detector can receive the data carried in the infra-red signal, and appropriate circuitry can place the data on bus 502. Bus 502 carries the data to main memory 506, from which processor 504 retrieves and executes the instructions. The instructions received by main memory 506 may optionally be stored on storage device 510 before or after execution by processor 504.

Computer system 500 also includes a communication interface 518 coupled to bus 502. Communication interface 518 provides a two-way data communication coupling to a network link 520 connected to a local network 522. For example, communication interface 518 may be an integrated service digital network (ISDN) card or a modem to connect data to a corresponding telephone line. Another example is communication interface 518, a local area network (LAN) card that provides a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication to other data devices through one or more networks. For example, network link 520 may provide a connection through local network 522 to a host computer 524 or data equipment operated by an Internet Service Provider (ISP) 526. ISP 526 provides data communication services through the worldwide packet data communication network, now commonly called the “Internet” 528. Local network 522 and Internet 528 both use electrical, electromagnetic, or optical signals that carry digital data streams.

Computer system 500 can send messages and receive data, including program code, through the network(s), network link 520, and communication interface 518. In the Internet example, server 530 might transmit a requested code for an application program through Internet 528, ISP 526, local network 522, and communication interface 518. The received code may be executed by processor 504 as it is received and/or stored in storage device 510, or other non-volatile storage for later execution.

In the foregoing specification, embodiments have been described with reference to numerous specific details that may vary from implementation to implementation. Thus, the sole and exclusive indicator of what is, and is intended by the applicants to be, the approach is the set of claims issued from this application in the specific form in which such claims are issued, including any subsequent correction. Hence, no limitation, element, property, feature, advantage, or attribute that is not expressly recited in a claim should limit the scope of such claim in any way. Accordingly, the specification and drawings should be regarded in an illustrative rather than a restrictive sense.

What is claimed is:

1. A computer-implemented method for generating a quadrilateral grid from an image with an alpha channel, the method comprising:
receiving an image with an alpha channel depicting a shape mapped onto a 3D surface;
vectorizing the shape found in the alpha channel to create a vector path;
determining corners of the vector path by:
calculating a centroid of the vector path;
identifying the farthest points from the centroid to establish corner points;
correcting a winding order and orientation of the vector path to ensure a clockwise order;
constructing a quadrilateral grid by setting sub-paths based on detected corners;
resampling the sub-paths to match a specified number of rows and columns;
performing weighted interpolation across the grid by:
calculating interpolants for each grid element based on inverse square distance weighting;
adjusting interpolated values by the distance from contributing edges;
outputting the generated quadrilateral grid; and
causing displaying the generated output of the quadrilateral grid on a computer display device.

2. The method of claim 1, where the generated output of the quadrilateral grid may be resampled to change an aspect ratio and size of the quadrilateral grid;
wherein the resampling is performed using interpolation and extrapolation;
wherein a resulting grid is used as input to a generative AI to refine or correct a portion of a synthetic image;
wherein the method further comprises normalizing the vector path to fit within a predefined coordinate system.

3. The method of claim 1, wherein the vectorizing includes smoothing the vector path using a spline interpolation.

4. The method of claim 1, wherein the centroid is calculated by averaging coordinates of the vector path's points.

5. The method of claim 1, further comprising verifying the clockwise order by calculating the 3D surface's normal of the quadrilateral.

6. The method of claim 1, wherein resampling the sub-paths involves linear interpolation to distribute points evenly.

7. The method of claim 1, wherein the weighted interpolation uses cubic weighting functions for enhanced accuracy.

8. The method of claim 1, further comprising displaying the generated quadrilateral grid on a graphical user interface.

9. An apparatus for generating a quadrilateral grid from an image with an alpha channel, comprising:
a processor configured to:
vectorize a shape found in the alpha channel of the image;
determine corners of the vectorized shape and correct a winding order to ensure a clockwise orientation;
construct a quadrilateral grid by setting sub-paths using detected corners, wherein the sub-paths are resampled to match a specified number of rows and columns;
perform weighted interpolation for each element of the grid based on inverse square distance, calculating interpolants and weights to provide a 3D mesh;
subdivide the 3D mesh for flexible manipulation and extrapolation without further calculations.

10. The apparatus of claim 9, wherein the processor is further configured to vectorize the shape using uniform distance sampling.

11. The apparatus of claim 10, wherein the processor determines corners of the vectorized shape using a centroid-based method.

12. The apparatus of claim 11, wherein the processor corrects the winding order by checking the shape's normal orientation.

13. The apparatus of claim 12, wherein the sub-paths are resampled to match specific grid dimensions using a predefined number of rows and columns.

14. The apparatus of claim 13, wherein the processor applies cubic weighting functions for the interpolation of each grid element.

15. The apparatus of claim 14, wherein the processor implements a rotation adjustment to align the grid with the image frame.

16. The apparatus of claim 15, wherein the 3D mesh is subdivided using specific algorithms for enhanced flexibility.

17. The apparatus of claim 16, wherein the processor utilizes a specific method for extrapolating the grid size.

18. A non-transitory, computer-readable storage medium storing one or more computer instructions which, when executed by one or more computer processors, cause the one or more computer processors to perform:
receiving an image with an alpha channel depicting a shape mapped onto a 3D surface;
vectorizing the shape found in the alpha channel to create a vector path;
determining corners of the vector path by:
calculating a centroid of the vector path;
identifying the farthest points from the centroid to establish corner points;
correcting a winding order and orientation of a vector path to ensure a clockwise order;
constructing a quadrilateral grid by setting sub-paths based on detected corners;
resampling the sub-paths to match a specified number of rows and columns;
performing weighted interpolation across the grid by:
calculating interpolants for each grid element based on inverse square distance weighting;
adjusting interpolated values by the distance from contributing edges;
outputting the constructed quadrilateral grid; and
causing displaying the generated output of the quadrilateral grid on a computer display device.

19. The non-transitory, computer-readable storage medium of claim 18, storing additional instructions for normalizing the vector path to fit within a predefined coordinate system.

20. The non-transitory, computer-readable storage medium of claim 18, wherein the vectorizing includes smoothing the vector path using a spline interpolation.
